(19) United States
(12) Patent Application Publication
(10) Pub. No.: US 2012/0295086 A1
(43) Pub. Date: Nov. 22, 2012

(54) CROSSLINKED POLYPROPYLENE FOAM SHEET FOR IMPROVED ANCHORAGE TO TPO

(75) Inventors: Jesse J. Baldwin, Strasburg, VA (US); Pawel Sieradzki, Cross Junction, VA (US); Gordon V. Sharps, JR., North Kingstown, RI (US)

(73) Assignee: TORAY PLASTICS (AMERICA), INC., North Kingstown, RI (US)

(21) Appl. No.: 13/339,928

(22) Filed: Dec. 29, 2011

Related U.S. Application Data
(60) Provisional application No. 61/487,092, filed on May 17, 2011.
(60) Provisional application No. 61/508,232, filed on Jul. 15, 2011.
(60) Provisional application No. 61/569,422, filed on Dec. 12, 2011.

(51) Int. Cl. B32B 27/08; B32B 27/32; B32B 5/18; C08F 110/06; C08L 23/12

(52) U.S. Cl. 428/215; 521/143; 521/134; 428/304.4; 428/319.7

(57) ABSTRACT

A foam composition comprising about 50 to about 95 parts by weight of at least one polypropylene polymer having a density of about 85 to about 125 kg/m³, wherein the composition has blister rating of 1-2, an unaged peel tear strength of at least about 34 N and a heat aged peel tear strength of at least about 28 N when laminated to a support layer.

### RELATED APPLICATIONS

This application-claims priority from Provisional Patent Application No. 61/487,092 filed May 17, 2011; 61/508,232 filed Jul. 15, 2011 and 61/569,422 filed Dec. 12, 2011, the entire disclosures of which are incorporated by reference herein.

### TECHNICAL FIELD

This disclosure relates to crosslinked polypropylene and polypropylene-polyethylene foams that maintain desired thermoforming and performance requirements and exhibit improved anchorage to support layers such as thermoplastic polyolefin (TPO).

### BACKGROUND

Physically crosslinked closed cell polypropylene and polypropylene-polyethylene blended foams are commercially produced and used in various applications. One such application is automobile interior trim. In automobile interiors, the door panels, the instrument panel, the center console, front seat armrests, and other interior components may contain a layer of polypropylene foam. The foam is typically immediately behind the surface layer of these trim components. In many cases, the surface layer of these trim components is a plastomeric, elasto-plastomeric, or elastomeric TPO.

Various manufacturing techniques are used to produce these automotive interior trim components. For example, some manufacturers use a TPO-polypropylene foam bilaminate and simultaneously vacuum form and adhere the bilaminate onto a plastic substrate to produce an interior trim panel.

Typically, these TPO-polypropylene bilaminates are produced by a third party laminator. In some cases, a laminator will directly extrude molten TPO onto the polypropylene foam and compress the materials in a “nip roll” to adhere the support layer TPO to the foam, thus creating a bilaminate. In other cases, a laminator will produce a sheet of TPO separately. The laminator then exposes the TPO sheet and/or the foam to heat and pressure to adhere the sheet to the foam, thus creating a bilaminate.

The anchorage and strength of the bond between the support layer/TPO and polypropylene foam is important. Poor anchorage creates undesirable performance characteristics. For example:
1) In cases where the bilaminate is vacuum formed onto a plastic substrate, the bilaminate may be heated to 180-210° C. Inadequate bonding may cause the TPO to blister and separate from the foam at elevated temperature.
2) In cases where the TPO-foam bilaminate is used in an instrument panel, the bilaminate needs to cleanly tear along seam lines to accommodate an airbag breaking through the bilaminate during a deployment. Inadequate adhesion or bond to the TPO may create undesirable separation between the foam and the TPO in the bilaminate during a deployment.

### SUMMARY

We provide a foam composition including about 50 to about 95 parts by weight of at least one polypropylene polymer having a density of about 85 to about 125 kg/m³, wherein the composition has blister rating of 1-2, an unaged peel tear strength of at least about 34 N and a heat aged peel tear strength of at least about 28 N when laminated to a support layer.

We also provide a laminate including the above foam composition laminated to the support layer.

We further provide a foam composition including about 50 to about 95 parts by weight of at least one polypropylene polymer having a density of about 50 to about 85 kg/m³, wherein the composition has blister rating of 1-2, an unaged peel tear strength of at least about 26 N and a heat aged peel tear strength of at least about 19 N when laminated to a support layer.

We still further provide a laminate including the above foam composition laminated to the support layer.

We yet further provide a foam composition including about 30 to about 50 parts by weight of at least one polypropylene polymer having a density of about 50 to about 85 kg/m³, wherein the composition has blister rating of 1-2, an unaged peel tear strength of at least about 17 N and a heat aged peel tear strength of at least about 15 N when laminated to a support layer.

We still yet further provide a laminate including the above foam composition laminated to the support layer.

### DETAILED DESCRIPTION

It will be appreciated that the following description provides details concerning selected representative aspects of the disclosure. It will also be appreciated that a wide variety of equivalents may be substituted for the specified elements of the methods, compositions and laminates described herein without departing from the spirit and scope of this disclosure as described in the appended claims. Additionally, all publications, including but not limited to patents and patent applications, cited herein are incorporated by reference as though fully set forth.

Ranges identified herein (e.g., 50 to 95%) include the values defining the upper and lower numerals of a recited range (e.g., 50 and 95%), all discrete values within the range (e.g., 51%, 51.1%, 52% and the like) and all discrete sub-ranges (e.g., 60% to 70%, 68% to 78% or 85% to 90%) within the range.

Those skilled in the art will also recognize that, consistent with probability theory and statistics, in some instances compositions equivalent to those described here may have one or more properties which differ from the exact values recited herein due to normal variation which can be described by a Gaussian distribution. Such compositions have values which may be considered “about” a given value. Additionally, those skilled in the art will recognize that preparations of olefin block copolymers having a controlled block sequence distribution or polypropylene based polymers useful in our compositions, laminates or methods may contain small amounts of antioxidants or other substances, which typically represent from 0% to 1% of the mass of such preparations. Consequently, those skilled in the art will recognize this when providing an amount of such a preparation that is “about” a particular value.

Selected properties described herein are defined and measured as follows:

The “melt flow index” (MFI) value for a polymer is defined and measured according to ASTM D1238 at 190° C. for polyethylenes and polyethylene based materials and at 230° C. for polypropylenes and polypropylene based materials using a 2.16 kg plunger for 10 minutes. The test time may be reduced for relatively high melt flow resins. MFI is also referred to as the “resin melt flow rate.”

The “melting temperature” (Tₘ), or “melting temperatures” for a polymer or polymer foam composition comprising a polymer is measured using differential scanning calorimetry (DSC). The melting temperatures are determined by first heating a 10 to 15 mg polymer or polymer foam composition sample from room temperature to 200° C. at 10° C./min. The sample is then cooled from 200° C. to room temperature at a rate of 10° C./min, followed by a second heating from room temperature to 200° C. at 10° C./min. The melting temperatures are the peak endotherm values identified during the second heating.

The “thickness” of the foam sheet is measured according to JIS K6767.

The “density” of the foam sheet is measured using section or “overall” density, rather than a “core” density, according to JIS K6767.

The “lamination surface density” of the foam sheet is measured by slicing 0.45-0.60 mm of the surface of the foam sheet intended to contact the TPO. The thickness and density of the sliced foam layer is measured according to JIS K6767.

“Overall crosslinking degree” is measured according to the “Toray Gel Fraction Method,” where tetralin solvent is used to dissolve non-crosslinked components. Non-crosslinked material is dissolved in tetralin and the crosslinking degree is expressed as the weight percentage of crosslinked material.

The apparatus used to determine the percent of polymer crosslinking includes: 100 mesh (0.0045″ wire diameter); type 304 stainless steel bags; numbered wires and clips; a Miyamoto thermostatic oil bath apparatus; an analytical balance; a fume hood; a gas burner; a high temperature oven; an anti-static gun; and three 3.5 liter wide mouth stainless steel containers with lids. Reagents and materials used include tetralin high molecular weight solvent, acetone, and silicone oil.

Specifically, an empty wire mesh bag is weighed and the weight recorded. For each sample, about 2 grams to about 10 grams±about 5 milligrams of sample is weighed out and transferred to the wire mesh bag. The weight of the wire mesh bag and the sample, typically in the form of foam cuttings, is recorded. Each bag is attached to the corresponding number wire and clips.

When the solvent temperature reaches 130° C., the bundle (bag and sample) is immersed in the solvent. The samples are shaken up and down about 5 or 6 times to loosen any air bubbles and fully wet the samples. The samples are attached to an agitator and agitated for three (3) hours so that the solvent can dissolve the foam. The samples are then cooled in a fume hood.

The samples are washed by shaking up and down about 7 or 8 times in a container of primary acetone. The samples are washed a second time in a second acetone wash. The washed samples are washed once more in a third container of fresh acetone as above. The samples are then hung in a fume hood to evaporate the acetone for about 1 to about 5 minutes.

The samples are then dried in a drying oven for about 1 hour at 120° C. The samples are cooled for a minimum of about 15 minutes. The wire mesh bag is weighed on an analytical balance and the weight is recorded.

Crosslinking degree is then calculated using the formula 100*(C−A)/(B−A), where A=empty wire mesh bag weight; B=wire bag weight+foam sample before immersion in tetralin; and C=wire bag weight+dissolved sample after immersion in tetralin.

“Lamination surface crosslinking degree” is measured by slicing 0.45-0.60 mm of the surface of the foam sheet intended to contact the support layer/TPO. The “Toray Gel Fraction Method” is used to quantify the amount of crosslinked material in the 0.45-0.60 mm slice.

“Compressive strength” is measured according to JIS K6767, where 50×50 mm precut foam is stacked to 25 mm and compressed at a rate of 10 mm/min to 75% of the original stacked height. The compression is then maintained for 20 seconds, after which the compressive strength is recorded.

The “blister rating” is an arbitrary rating of 1-5 describing the amount and severity of TPO delamination after exposure of a support layer/TPO-foam bilaminate to 160° C. for 10 minutes. “1” indicates no delamination. “5” indicates severe delamination.

The “peel tear strength” is defined and measured according to TSL5601G where 25 mm×150 mm strips of support layer/TPO-foam bilaminate are pulled apart at 200 mm/min in both the machine direction and transverse (cross) machine direction.

The disclosed foam compositions may be obtained by blending a composition of base polymer resin(s) with a crosslinking monomer and chemical blowing agent.

The foam compositions may contain about 30 to about 95 parts, preferably about 40 to about 90 parts, by weight polypropylene and/or polypropylene base polymer.

As used herein “parts by weight” values refer to the mass of a component, (e.g., copolymer in a foam composition) present in a given composition, (e.g., a foam composition) relative to the total mass of the base polymer resins (impact polypropylene homopolymer (impact hPP) plus polypropylene random copolymer (PP RCP) plus linear low density polyethylene (LLDPE) plus crystalline olefin-ethylene butylene-crystalline olefin (CEBC) plus very low density polyethylene (VLDPE) plus ethylene/α-olefin interpolymer (OBC)).

It is preferred that the base polymer resins have a particular MFI of about 0.1 to about 15 g/min at 230° C. and 2.16 kg as determined by ASTM D1238 for impact hPP, PP RCP, and CEBC. It is preferred that the base polymer resins have a particular MFI of about 0.1 to about 15 g/min at 190° C. and 2.16 kg as determined by ASTM D1238 for LLDPE, CEBC, VLDPE and OBC.

As discussed above, the MFI provides a measure of the flow characteristics of a polymer and is an indication of the molecular weight and processability of a polymer material. If the MFI values are too high, which corresponds to a low viscosity, extrusion steps become difficult to satisfactorily carry out. Problems associated with MFI values that are too high include low pressures during melt processing, problems with calendaring and setting a sheet thickness profile, uneven cooling profile due to low melt viscosity, poor melt strength and/or machine problems. MFI values that are too low include high pressures during melt processing, difficulties in calendaring, sheet quality and profile problems, and higher processing temperatures which cause a risk of foaming agent decomposition and activation.

The above MFI ranges are also important for foaming steps because they reflect the viscosity of the material and viscosity effects the melt strength and roughness of the material. We believe there are several reasons why particular MFI values are far more effective for our foam compositions. A lower MFI material may improve some physical properties as the molecular chain length is higher, creating more energy needed for chains to flow when a stress is applied. Also, the longer the molecular chain (M_{w}), the more crystal entities the chain can crystallize, thus providing more strength through intermolecular ties. However, at too low a MFI, the viscosity becomes too high. On the other hand, materials with higher MFI values have shorter chains. Therefore, in a given volume of a material with higher MFI values, there are more chain ends on a microscopic level relative to materials having a lower MFI, which can rotate and create free volume due to the space needed for such rotation (e.g., rotation occurring above the T_{g}, or glass transition temperature of the polymer). This increases the free volume and enables an easy flow under stress forces. The MFI should be within the described ranges to provide an appropriate balance between these properties.

During preparation of the foam compositions, the base polymer resins are blended and combined with a crosslinking monomer to adapt or improve properties of the foam compositions by modifying the degree of crosslinking. The crosslinking degree or degree of crosslinking is determined according to the “Toray Gel Fraction Method” where, as described above, tetralin solvent is used to dissolve non-crosslinked components.

Suitable crosslinking monomers include commercially available difunctional, trifunctional, tetrafunctional, pentafunctional, and higher functionality monomers. Such crosslinking monomers are available in liquid, solid, pellet and powder forms. Examples include, but are not limited to, acrylates or methacrylates such as 1,6-hexanediol diacrylate, 1,6-hexanediol dimethacrylate, ethylene glycol diacrylate, ethylene glycol dimethacrylate, trimethylol propane trimethacrylate, tetramethylol methane triacrylate, 1,9-nonanediol dimethacrylate and 1,10-decanediol dimethacrylate; allyl esters of carboxylic acid (such as trimellitic acid triallyl ester, pyromellitic acid triallyl ester, oxalic acid diallyl ester and the like); allyl esters of cyanulic acid or isocyanulic acid such as triallyl cyanurate and triallyl isocyanurate; maleimide compounds such as N-phenyl maleimide and N,N′-m-phenylene bismaleimide; compounds having at least two tribonds such as phthalic acid dipropagyl, maleic acid dipropagyl and the like; and divinylbenzene. About 80% pure divinylbenzene (DVB), a difunctional liquid crosslinking monomer, may preferably be used in amounts from about 0.1 to about 7.5 parts per hundred units resin (PPHR) and most preferably in amounts from about 2.5 to about 3.75 PPHR. Thus, the foam compositions preferably comprise amounts of DVB from about 0.08 to about 6.0 PPHR and most preferably in amounts from about 2.0 to about 3.0 PPHR.

Additionally, such crosslinking monomers may be used alone or in any combination. Importantly, crosslinks may be generated using a variety of different techniques and can be formed both intermolecularly between different polymer molecules and intramolecularly between portions of a single polymer molecule. Such techniques include providing crosslinking monomers separate from a polymer chain and providing polymer chains which incorporate a crosslinking monomer containing a functional group which can form a crosslink or be activated to form a crosslink.

Typically, the composition to be blended is also combined with a thermally decomposable chemical blowing agent and/or foaming agent. Generally, there is no restriction on the type of chemical blowing agents. Examples of chemical blowing agents include azo compounds, hydrazine compounds, carbazides, tetrazoles, nitroso compounds, carbonates and the like. A chemical blowing agent may be employed alone or in any combination. Azodicarbonamide (ADCA) is preferably used as the chemical blowing agent. Importantly, ADCA molecules are typically thermally decomposed during blowing or foaming steps. The thermal decomposition products of ADCA include nitrogen, carbon monoxide, carbon dioxide and ammonia. ADCA thermal decomposition typically occurs at temperatures between about 190 to about 230° C. By controlling the amount of the chemical blowing agent, the section density of the produced foam compositions can be controlled. Acceptable amounts of blowing agent for an intended foam section density can be readily determined. The chemical blowing agent is generally used in an amount of about 2.0 to about 25.0 parts by weight depending on the required density. For azodicarbonamide, about 4.0 to about 8.0 parts by weight is preferred for a 67 kg/m³ foam section density.

If the difference between the decomposition temperature of the thermally decomposable blowing agent and the melting point of the resin blend is high, then a catalyst for blowing agent decomposition may be used. Exemplary catalysts include, but are not limited to, zinc oxide, magnesium oxide, calcium stearate, glycerin, urea and the like.

The foam compositions may also contain further additives compatible with producing the disclosed foam compositions. Common additives include, but are not limited to, organic peroxides, antioxidants, lubricants, thermal stabilizers, colorants, flame retardants, antistatic agents, nucleating agents, plasticizers, antimicrobials, antifungals, light stabilizers, UV absorbents, anti-blocking agents, fillers, deodorizers, thickeners, cell size stabilizers, metal deactivators and combinations thereof.

The components of the foam compositions may be mechanically pre-mixed, when desired, to facilitate their dispersal. A Henshel mixer may preferably be used for such pre-mixing. If the crosslinking monomer or any other additive is a liquid, the monomer and/or additives can be added through a feeding gate of an extruder or through a vent opening of an extruder equipped with a vent instead of being pre-mixed with the solid ingredients.

The mixed components of the foam compositions, including the crosslinking monomer and chemical blowing agent, are melted after blending at a temperature range below the decomposition temperature of the thermally decomposable blowing agent and kneaded with a kneading device such as a single screw extruder, twin screw extruder, Banbury mixer, kneader mixer or mixing roll. The resulting melted preparation is then typically formed into a sheet-like material (e.g., a sheet, film, web or the like). Preferably, the sheet-like material is extruded with a twin-screw extruder. Another possibility for forming the sheet-like material is to use calendaring.

The melting, kneading and/or calendaring temperature is preferably at least about 10° C. below the decomposition initiation temperature of the blowing agent. If this temperature is too high, then the thermally decomposable blowing agent may decompose upon kneading, which typically results in undesirable prefoaming. The lower temperature limit for kneading and/or calendaring is the melting point of the polypropylene resin (or the greater of the two melting points if two polypropylene resins are used) in the composition. By kneading or calendaring the composition between these two temperature limits, a regular cell structure and a flat foam surface is obtainable once the sheet-like material is foamed.

Subsequently, the sheet-like material is subjected to irradiation with ionizing radiation at a given exposure to crosslink the composition, thereby obtaining a crosslinked sheet.

The foam compositions may contain crosslinks produced by any known method including, for example, irradiating with an ionized radiation at a given exposure or crosslinking with an organic peroxide or silane. It should be noted that irradiating with ionizing radiation produces a foam sheet comprising the disclosed compositions, which has an excellent surface appearance and substantially uniform cells. In the past, ionizing radiation was unable to produce a sufficient degree of crosslinking when such a foam sheet was prepared with compositions comprising primarily polypropylene(s). The methods and compositions of the disclosure solve this problem. Thus, polypropylene(s) can be sufficiently crosslinked with ionizing radiation by adding a crosslinking monomer in the methods and compositions of the disclosure.

Examples of ionizing radiation include, but are not limited to, alpha rays, beta rays, gamma rays, and electron beams. Among them, an electron beam having substantially uniform energy is preferably used to prepare the foam compositions of the disclosure. Exposure time, frequency of irradiation and acceleration voltage upon irradiation with an electron beam can vary widely depending on the intended crosslinking degree and the thickness of the sheet-like material. However, it should generally be in the range of from about 10 to about 500 kGy, and preferably from about 20 to about 300 kGy, and more preferably from about 20 to about 200 kGy. If the exposure is too low, cell stability is not maintained upon foaming. If the exposure is too high, moldability of the resulting sheet comprising the foam compositions may be poor, or alternatively, the components themselves may be degraded. Also, the components present (e.g., polymers) may be softened by exothermic heat release upon exposure to electron beam radiation so that the sheet can deform when exposure is too high.

The irradiation frequency is preferably no more than four times, more preferably no more than two times, and even more preferably just one time. If the radiation frequency is more than about four (4) times, then excessive chain scission will cause undesirable reduction in physical properties. Also, the components themselves may suffer degradation so that upon foaming, for example, substantially uniform cells will not be created in the resulting foam compositions.

When the thickness of the sheet-like material comprising the components of the foam compositions is greater than about 4 mm, irradiating each primary surface of this material with an ionized radiation is preferred to make the degree of crosslinking of the primary surface(s) and the inner layer more uniform.

Irradiation with an electron beam provides an advantage in that sheet-like materials comprising the components of the foam compositions and having various thicknesses can be effectively crosslinked by controlling the acceleration voltage of the electrons. The acceleration voltage is generally in the range of from about 200 to about 1500 kV, and preferably from about 400 to about 1200 kV, and more preferably about 600 to about 1000 kV. If the acceleration voltage is less than about 200 kV, the radiation cannot penetrate to crosslink the inner portion of the sheet-like material. As a result, the cells in the inner portion can be coarse and uneven on foaming. If the acceleration voltage is greater than about 1500 kV, the components themselves may degrade.

Regardless of the crosslinking technique selected, crosslinking is performed so that the foam compositions have an overall crosslinking degree of about 20 to about 75%, more preferably about 30 to about 60%, as measured by the “Toray Gel Fraction Method.”

Regardless of the crosslinking technique selected, lamination surface crosslinking is performed so that the foam compositions have a lamination surface crosslinking degree of about 15% to about 65%, more preferably from about 25% to about 55%.

Foaming is typically accomplished by heating the crosslinked sheet-like material to a temperature higher than the decomposition temperature of the thermally decomposable blowing agent. For the thermally decomposable blowing agent azodicarbonamide (ADCA), foaming is performed at about 200 to about 260° C., preferably about 220 to about 240° C., in a continuous process. Typically, foaming is not performed as a batch process. Instead, continuous, processes are preferred for preparation of the foam compositions or articles incorporating the foam compositions.

Foaming is typically conducted by heating the crosslinked sheet-like material with molten salt, radiant heaters, vertical hot air oven, horizontal hot air oven, microwave energy or a combination of these methods. The foaming may also be conducted in an impregnation process using, for example, nitrogen in an autoclave, followed by a free foaming via molten salt, radiant heaters, vertical hot air oven, horizontal hot air oven, microwave energy or a combination of these methods. A preferred combination of molten salt and radiant heaters is used to heat the crosslinked sheet-like material.

Optionally, before foaming, the crosslinked sheet-like material can be softened with preheating. This helps stabilize the expansion of the sheet-like material upon foaming.

Production of the crosslinked foam compositions is typically accomplished using a multi-step process comprising: 1) mixing/extrusion or mixing/kneading or mixing/calendaring a polymer matrix sheet; 2) crosslinking with a radiation source such as electron beam; and 3) a foaming process where the material is heated via a) molten salt, radiant heaters, hot air ovens, or microwave energy, or b) in an impregnation process with nitrogen in an autoclave followed by heating the material via molten salt, radiant heaters, hot air oven, or microwave energy.

A preferred process to make the foam compositions such as a foam sheet, preferably comprises extrusion/kneading by mixing, kneading and extruding a sheet-like material; crosslinking by physical crosslinking the sheet-like material with an electron beam; foaming the sheet-like material through decomposition of an organic blowing agent added during mixing where the agent is azodicarbonamide (ADCA); and expansion by heating with molten salt and/or radiant heaters.

Preferably, the processes for making the foam compositions are conducted such that a foam composition with a section, or “overall” density of about 20 to about 250 kg/m³ or, preferably, about 50 kg/m³ to about 125 kg/m³, is obtained as measured by JIS K6767. The section density can be controlled by the amount of blowing agent. If the density of the foam sheet is less than about 20 kg/m³, the sheet does not foam efficiently due to a large amount of chemical blowing agent needed to attain the density. Additionally, if the density of the foam sheet is less than about 20 kg/m³, expansion of the sheet during the foaming process becomes increasingly difficult to control. Thus, it becomes increasingly more difficult to produce a foam sheet of uniform section density and thickness. Additionally, if the density of the foam sheet is less than 20 kg/m³, the foam sheet becomes increasingly prone to cell collapse.

Preferably, processes for making the foam compositions are conducted such that a foam composition with a lamination surface density of about 35 to about 275 kg/m³ or, preferably, about 65 kg/m³ to about 140 kg/m³, is obtained on the 0.45 mm to 0.60 mm side of the foam intended to contact the support layer, measured according to JIS K6767.

The foam compositions are not limited to a section density of about 250 kg/m³. A foam of about 350 kg/m³, about 450 kg/m³, or about 550 kg/m³ may also be produced. However, it is preferred that the foam compositions have a density of less than about 250 kg/m³.

The average cell size is preferably from about 0.05 to about 1.0 mm and most preferably from about 0.1 to about 0.7 mm. If the average cell size is lower than about 0.05 mm, the foam compositions have reduced softness, haptics and flexibility. If the average cell size is larger than 1 mm, the foam compositions will have an uneven surface. There is also a possibility of the foam compositions being undesirably torn if the population of cells in the foam does not have the preferred average cell size where the foam composition is stretched or portions that are subjected to a secondary process. The cell size in the foam compositions may have a bimodal distribution representing a population of cells in the core of the foam compositions which are relatively round and a population of cells in the skin near the surfaces of the foam compositions which are relatively flat, thin and/or oblong.

The thickness of the foam compositions may be from about 0.2 mm to about 50 mm, preferably from about 0.4 mm to about 40 mm, more preferably from about 0.6 mm to about 30 mm and even more preferably from about 0.8 mm to about 20 mm. If the thickness is less than about 0.2 mm, foaming is not efficient due to significant gas loss from the primary surfaces. If the thickness is greater than about 50 mm, expansion during the foaming process becomes increasingly difficult to control. Thus, it is increasingly more difficult to produce a foam sheet comprising the foam compositions with uniform section density and thickness. The desired thickness can also be obtained by a secondary process such as slicing, skiving or bonding. Slicing, skiving or bonding can produce a thickness range of about 0.1 mm to about 100 mm. The thickness of the support layer such as TPO may be about 0.2 mm to about 1.2 mm.

The compressive strength of the foam compositions will vary according to section density, type of base polymer resins, and the quantity of each base polymer resin in the compositions. The compressive strength is measured, as described above, according to JIS K6767, where 50×50 mm pre-cut foam is stacked to about 25 mm and compressed at a rate of 10 mm/min to 75% of the original stacked height. The compression is then maintained for 20 seconds, after which the compressive strength is recorded.

The polypropylene(s) comprising the base polymer resins may be polypropylene or may contain an elastic component, typically an ethylene component. Thus, the base polymer may be selected from, but not limited to, polypropylene, impact modified polypropylene, polypropylene-ethylene copolymer, metallocene polypropylene, metallocene polypropylene-ethylene copolymer, polypropylene based polyolefin plastomer, polypropylene based polyolefin elasto-plastomer, polypropylene based polyolefin elastomer, polypropylene based thermoplastic polyolefin blend and polypropylene based thermoplastic elastomeric blend.

The melting temperature of the polypropylene based material in the methods and compositions may preferably be at least about 125° C. and most preferably more than about 135° C. If the polypropylene based material has a melting temperature below about 125° C., good peel tear strength may not be obtained in a support layer/foam laminate composition after heat aging for 120 hours at 120° C.

An illustrative example of polypropylene is an isotactic homopolypropylene although other polypropylenes may be used.

An illustrative example of an impact modified polypropylene is a homopolypropylene with ethylene-propylene copolymer rubber or ethylene-propylene-(nonconjugated diene) copolymer rubber. Two specific examples are the TI4015F and TI4015F2 resins commercially available from Braskem PP Americas.

Metallocene polypropylenes include, but are not limited to, metallocene syndiotactic homopolypropylene, metallocene atactic homopolypropylene, or metallocene isotactic homopolypropylene. Examples of metallocene polypropylenes are those commercially available under the trade names METOCENE™ from LyondellBasell and ACHIEVE™ from ExxonMobil. Metallocene polypropylenes are also commercially available from Total Petrochemicals USA and include grades M3551, M3282MZ, M7672, 1251, 1471, 1571, and 1751.

Polypropylene based polyolefin plastomer (POP) and/or polypropylene based polyolefin elastoplastomer is a propylene based copolymer. Nonlimiting examples of polypropylene based polyolefin plastomer polymers are those commercially available under the trade name VERSIFY™ from the Dow Chemical Company and VISTAMAXX™ from ExxonMobil.

Polypropylene based polyolefin elastomer (POE) is a propylene based copolymer. Nonlimiting examples of propylene based polyolefin elastomers are those polymers commercially available under the trade names THERMORUN™ and ZELAS™ from Mitsubishi Chemical Corporation, ADFLEX™ and SOFTELL™ from LyondellBasell, VERSIFY™ from the Dow Chemical Company and VISTAMAXX™ from ExxonMobil.

Polypropylene based thermoplastic polyolefin blend (TPO) is homopolypropylene and/or polypropylene-ethylene copolymer and/or metallocene homopolypropylene, any of which may have ethylene-propylene (EP) copolymer rubber or ethylene-propylene (nonconjugated diene) (EPDM) copolymer rubber in amounts great enough to give the thermoplastic polyolefin blend (TPO) plastomeric, elastoplastomeric or elastomeric properties. Nonlimiting examples of polypropylene based polyolefin blend polymers are those polymer blends commercially available under the trade names EXCELINK™ from JSR Corporation, THERMORUN™ and ZELAS™ from Mitsubishi Chemical Corporation, FERROFLEX™ and RxLOY™ from Ferro Corporation and TELCAR™ from Teknor Apex Company.

Polypropylene based thermoplastic elastomer blend (TPE) is homopolypropylene and/or polypropylene-ethylene copolymer and/or metallocene homopolypropylene, any of which may have diblock or multiblock thermoplastic rubber modifiers (SEBS, SEPS, SEEPS, SEP, SERC, CEBC, HSB and the like) in amounts great enough to give the thermoplastic elastomer blend (TPE) plastomeric, elastoplastomeric or elastomeric properties. Nonlimiting examples of polypropylene based thermoplastic elastomer blend polymers are those polymer blends commercially available under the trade name DYNAFLEX® and VERSAFLEX® from GLS Corporation, MONPRENE® and TEKRON® from Teknor Apex Company and DURAGRIP® from Advanced Polymer Alloys.

We also provide a laminate composition comprising a first layer of a foam composition and a second support layer which may be, but is not limited to, a plastomeric, elasto-plastomeric, or elastomeric thermoplastic polyolefin TPO layer.

Such laminates may be manufactured using well known standard techniques. Our foams may be laminated on one or both sides of the support layer. Additional layers/substrates may also be laminated to the resulting bi-laminate to suit selected applications.

The foam compositions or laminate, compositions can preferably be used in a variety of applications such as automotive applications, including but not limited to, automobile interior parts such as door panels, door rolls, door inserts, door stuffers, trunk stuffers, armrests, center consoles, seat cushions, seat backs, headrests, seat back panels, instrument panels, knee bolsters or a headliner.

Our foam sheet and laminate compositions may be subjected to various secondary processes, including and not limited to, embossing, corona or plasma or flame treatment, surface roughening, surface smoothing, perforation or microperforation, splicing, slicing, skiving, layering, bonding, hole punching and the like.

Factors effecting anchorage/interfacial bond strength between the foam compositions and support layers such as TPO as one example include, but are not limited to:
1) The temperature that the lamination surface of the TPO is heated to prior to contact with the foam;
2) The temperature that the lamination surface of the polypropylene foam is heated to prior to contact with the TPO;
3) The pressure applied to the TPO and foam during lamination;
4) The TPO ingredients;
5) The polypropylene foam ingredients;
6) The amount and type (if any) of physical or chemical crosslinking in the TPO;
7) The amount and type of physical crosslinking in the polypropylene foam;
8) The compatibility and/or polymer chain intermingling and/or amount of miscibility between the TPO and polypropylene foam;
9) The roughness or smoothness of the lamination surface of the TPO (if the TPO sheet is produced separately); and
10) The roughness or smoothness of the lamination surface of the polypropylene foam.

Some laminators are limited in their ability to modify the factors listed above. For example:
1) The lamination equipment may not be designed to heat the lamination surface of the TPO and/or the lamination surface of the polypropylene foam to temperatures most desirable for lamination;
2) The lamination equipment may not be designed to apply the most desirable pressure to the TPO and foam during lamination;
3) The laminator may be limited to certain TPO formulations which are less favorable for quality adhesion to polypropylene; and
4) The TPO and foam manufacturer may be limited by the interior trim manufacturer specifying amount and type of crosslinking in the TPO and/or polypropylene foam which may be less favorable for good lamination.

As a result, we addressed these limitations and discovered that there are certain polypropylene and polypropylene-polyethylene blended foams that exhibit significantly improved anchorage to support layers such as TPO. Representative examples are listed in Table I. In contrast, the comparative commercial polypropylene and polypropylene-polyethylene blended foams listed in Table II exhibit undesirable anchorage to TPO.

Traditional polypropylene foams such as those listed in Table II have good thermoforming capability required to produce an interior trim panel. However, it is difficult to achieve desirable anchorage/interfacial bond strength to a TPO with these foams in most lamination processes to be suitable for some instrument panel applications, door panel applications or the like.

### EXAMPLES

Foams were laminated in four lamination processes, each using a different TPO.

### Lamination Process “A”

In lamination process A, the foam surface is heated prior to lamination. TPO is directly extruded onto the heated foam and both are then pulled through a nip creating a laminate.

The foams evaluated in lamination process A are about 100 kg/m3 in density. The foams in Examples A1 and A2 are 90% polypropylene and 10% CEBC. The foams in Examples A3, A4, and A5 are 70% polypropylene, 20% LLDPE, and 10% CEBC. The foam in Example A6 is 62.5% polypropylene and 37.5% VLDPE. The bilaminates in examples A1-A6 exhibit a blister rating of 1, unaged peel tear strengths≧about 34 N, and heat aged peel tear strengths≧about 28 N.

The foams in Comparative Examples A1-A5 are 80% polypropylene and 20% LLDPE. The bilaminate in Comparative Example A1 exhibits a blister rating of 5, unaged peel tear strength<34 N, and heat aged peel tear strength<28 N. The bilaminates in Comparative Examples A2-A5 exhibit a blister rating of 1, unaged peel tear strengths≧about 34 N, and heat aged peel tear strengths<28 N.

Examples A1-A5 demonstrate that by substituting 10% PP RCP and/or LLDPE with CEBC, anchorage between the foam and TPO improves so that unaged peel tear strengths are ≧about 34 N and heat aged peel tear strengths<28 N.

Example A6 demonstrates that by substituting 37.5% 10% PP RCP and/or LLDPE with VLDPE, anchorage between the foam and TPO improves so that unaged peel tear strengths are ≧about 34 N and heat aged peel tear strengths<28 N.

### Lamination Process “B”

In lamination process B, the foam surface is not heated prior to lamination. TPO skin is produced separately, about 1 week prior to lamination. In lamination process B, the TPO skin is heated and then both heated TPO and unheated foam is pulled through a nip creating a laminate.

The foams evaluated in lamination process B are about 100 kg/m3 in density. Some of the foams evaluated in lamination process B were also evaluated in lamination process A. The foam in Example B1 is 90% polypropylene and 10% CEBC. The foams in examples B2 and B3 are 70% polypropylene, 20% LLDPE, and 10% CEBC. The bilaminates in Examples B1-B3 exhibit a blister rating of 1, unaged peel tear strengths≧about 34 N, and heat aged peel tear strengths≧about 28 N.

The foams in Comparative Examples B1 and B2 are 80% polypropylene and 20% LLDPE. The bilaminates in Comparative Examples B1 and B2 exhibit a blister rating of 1, unaged peel tear strength<34 N, and heat aged peel tear strength<28 N. The bilaminates in Comparative Examples A2-A5 exhibit a blister rating of 1, unaged peel tear strengths≧about 34 N, and heat aged peel tear strengths<28 N.

Examples B1-B3 demonstrate that by substituting 10% PP RCP and/or LLDPE with CEBC, anchorage between the foam and TPO improves so that unaged peel tear strengths are ≧about 34 N and heat aged peel tear strengths<28 N. This occurs despite the difference in lamination process and TPO composition.

### Lamination Process “C”

In lamination process C, the foam surface is not heated prior to lamination. TPO skin is produced separately, about 1 week prior to lamination. In lamination process C, the TPO skin is heated and then both heated TPO and unheated foam is pulled through a nip creating a laminate.

The foams evaluated in lamination process C are about 67 kg/m3 in density. The foams in Examples C1-C3 are 80% polypropylene and 20% VLDPE. The bilaminates in Examples C1-C3 exhibit a blister rating of 1, unaged peel tear strengths≧about 26 N, and heat aged peel tear strengths≧about 19 N.

The foams in Comparative Examples C1 and C2 are 80% polypropylene and 20% LLDPE. The foam in Comparative Example C3 is 70% polypropylene, 20% LLDPE, and 10% CEBC. The bilaminate in Comparative Example C1 exhibits a blister rating of 4, unaged peel tear strength≧about 26 N, and heat aged peel tear strength≧19 N. The bilaminate in Comparative Example C2 exhibits a blister rating of 5, unaged peel tear strength<26 N, and heat aged peel tear strength≧19 N. The bilaminate in Comparative Example C3 exhibits a blister rating of 5, unaged peel tear strength≧about 26 N, and heat aged peel tear strength<19 N.

Examples C1-C3 demonstrate that by substituting i) 30% PP RCP with impact hPP and ii) 20% LLDPE with VLDPE, anchorage between the foam and TPO improves so that unaged peel tear strengths are ≧about 26 N and heat aged peel tear strengths≧about 19 N.

However, unlike lamination processes A and B, substituting 10% PP RCP with 10% CEBC (Comparative Example C3) did not dramatically improve the anchorage between the foam and TPO. This is attributed to the different lamination process and TPO type where CEBC is not as effective in improving anchorage between the foam and TPO.

### Lamination Process “D”

In lamination process D, the foam surface is not heated prior to lamination. TPO skin is produced separately, about 1 week prior to lamination. In lamination process D, the TPO skin is heated and then both heated TPO and unheated foam is pulled through a nip creating a laminate.

The foams evaluated in lamination process D range from about 65 kg/m3 in density to 84 kg/m3 in density. The foams in Examples D1-D3 are 40% polypropylene, 50% OBC, and 10% CEBC. The bilaminates in Examples D1-D3 exhibit a blister rating of 1, unaged peel tear strengths≧about 17 N, and heat aged peel tear strengths≧about 15 N.

The foam in Comparative Example D1 is from about 66 kg/m3 in density to about 78 kg/m3 in density. The foam in Comparative Example D1 is 40% polypropylene and 60% OBC. The bilaminate in Example D1 exhibits a blister rating of 1, unaged peel tear strength<17 N, and heat aged peel tear strength<15 N in the machine direction.

Examples D1-D3 demonstrate that by substituting 10% OBC with CEBC, anchorage between the foam and TPO improves so that unaged peel tear strengths are ≧about 17 N and heat aged peel tear strengths<15 N.

TABLE I

| Resins | | | | | | | | | | | | |
|---|---|---|---|---|---|---|---|---|---|---|---|---|
| | | | | | | | DSC methods | Additives | | | | |
| | | | | | | | temperature | DVB | ADCA [symbol] | u [symbol] | [symbol] | |
| | | | | | amount | MF | peak | Uu [symbol] iot [symbol] | [symbol] off | package | package | [symbol] |
| example | resin type | form | manufacturer | commercial name | (%) | (2.16 [symbol] ) | (° C.) | (PPHR) | (PPHR) | (PPHR) | (PPHR) | (PPHR) |
| example A1 & | PP RCP | pulverized pellet | Brasken PP Americas | TR3020 [symbol] | 40 | 1.7-2.5 (230° C.) | 146-148 | 3.45-3.55 | 3.70-3.80 | 7.70-7.80 | 0.67-0.97 | |
| B1 | PP RCP | flake | Total Petrochemicals, USA | 7250FL | 50 | 1.3-1.5 (230° C.) | 137-139 | | | (“PR023”) | (“PR015”) | |
| | CEBC | pellet | JER Corporation | Dynamn 6200P | 10 | 1.0-3.0 (230° C.) | 94-96 | | | | | |
| example A2 | PP RCP | pulverized pellet | Total Petrochemicals, USA | 6232 | 40 | 1.6-2.4 (230° C.) | 146-148 | 3.45-3.55 | 3.70-3.80 | 7.70-7.80 | 0.67-0.97 | |
| | PP RCP | flake | Total Petrochemicals, USA | 7250FL | 50 | 1.3-1.6 (230° C.) | 137-139 | | | (“PR023”) | (“PR015”) | |
| | CEBC | pellet | JER Corporation | Dynamn 6200P | 10 | 1.0-5.0 (230° C.) | 94-96 | | | | | |
| example A3 & | PP RCP | pulverized pellet | Brasken PP Americas | TR302 [symbol] F | 40 | 1.7-2.5 (230° C.) | 146-148 | 3.45-3.55 | 3.70-3.80 | 7.70-7.00 | 0.67-0.97 | |
| B2 | PP RCP | flake | Total Petrochemicals, USA | T250FL | 30 | 1.9-1.6 (230° C.) | 137-139 | | | (“PR023”) | (“PR015”) | |
| | LLOPE | pulverized pellet | Exxonmobil Chemical Co. | LLP0501 67 | 20 | 5.9-7.5 (190° C.) | 125-127 | | | | | |
| | CEBC | pellet | JSR Corporation | Dynamn 6200P | 10 | 1.0-5.0 (230° C.) | 94-96 | | | | | |
| example A4 & | PP RCP | pulverized pellet | Brasken PP Americas | TR3020F | 40 | 1.7-2.5 (230° C.) | 146-148 | 3.45-3.55 | 3.70-3.80 | 7.70-7.80 | 0.67-0.97 | |
| B3 | PP RCP | flake | Total Petrochemicals, USA | 720CFL | 30 | 1.3-1.6 (230° C.) | 137-139 | | | (“PR023”) | (“PR015”) | |
| | LLOPE | pulverized pellet | Exxonmobil Chemical Co. | LLP6601 57 | 20 | 5.9-7.5 (190° C.) | 125-127 | | | | | |
| | CEBC | pellet | JSR Corporation | Dynamn 6200P | 10 | 1.0-5.0 (230° C.) | 94-96 | | | | | |
| example A3 | PP RCP | pulverized pellet | Total Petrochemicals, USA | 6732 | 40 | 1.6-2.4 (230° C.) | 146-148 | 3.45-3.55 | 3.70-3.80 | 7.70-7.00 | 0.67-0.97 | |
| | PP RCP | flake | Total Petrochemicals, USA | 7250FL | 30 | 1.3-1.6 (230° C.) | 137-139 | | | (“PR023”) | (“PR015”) | |
| | LLOPE | pulverized pellet | Exxonmobil Chemical Co. | LLP8501.67 | 20 | 5.9-7.5 (190° C.) | 125-127 | | | | | |
| | CEBC | pellet | JSR Corporation | Dynamn 6200P | 10 | 1.0-5.0 (230° C.) | 94-96 | | | | | |
| example A4 | PP RCP | flake | Total Petrochemicals, USA | 7250FL | 52.5 | 1.3-1.5 (230° C.) | 137-139 | 3.45-3.55 | 3.70-3.80 | 7.70-7.80 | 0.67-0.97 | |
| | VLDPB | pulverized pellet | Dow Chemical Company | Fle [symbol] ™ ETS-0078 | 37.5 | 2.2-2.8 (190° C.) | 119-121 | | | (“PR023”) | (“PR015”) | |
| example C1 | impact hPP | pulverized pellet | Brasken PP Americas | H4C16F/H4015F1 | 30 | 1.4-2.0 (230° C.) | 166-168 | 3.20-3.30 | 7.90-0.05 | 4.93-6.05 | | 2.96-3.05 |
| | PP RCP | pulverized pellet | Brasken PP Americas | TR3020F | 50 | 1.7-2.5 (230° C.) | 146-148 | | | (“PR023”) | | (“PR043”) |
| | VLDPE | pulverized pellet | Dow Chemical Company | Fle [symbol] ™ ETS-0078 | 20 | 2.2-2.5 (230° C.) | 119-121 | | | | | |
| example C2 | impact hPP | pulverized pellet | Brasken PP Americas | H4C16F/H4015F1 | 30 | 1.4-2.0 (230° C.) | 166-168 | 3.20-3.30 | 7.90-6.05 | 4.93-6.05 | | 2.96-3.05 |
| | PP RCP | pulverized pellet | Brasken PP Americas | TR3020F | 50 | 1.7-2.5 (230° C.) | 146-148 | | | (“PR023”) | | (“PR043”) |
| | VLDPE | pulverized pellet | Dow Chemical Company | Fle [symbol] ™ ETS-0078 | 20 | 2.2-2.0 (230° C.) | 119-121 | | | | | |
| example C3 | impact hPP | pulverized pellet | Brasken PP Americas | H4C16F/H4015F1 | 30 | 1.4-2.0 (230° C.) | 166-168 | 3.20-3.30 | 7.90-6.05 | 4.93-6.05 | | 2.96-3.05 |
| | PP RCP | pulverized pellet | Brasken PP Americas | TR3020F | 50 | 1.7-2.5 (230° C.) | 146-148 | | | (“PR023”) | | (“PR043”) |
| | VLDPE | pulverized pellet | Dow Chemical Company | Fle [symbol] ™ ETS-0078 | 20 | 2.2-2.5 (230° C.) | 119-121 | | | | | |
| example D1 | PP RCP | pulverized pellet | Total Petrochemicals, USA | 6232 | 40 | 1.6-2.4 (230° C.) | 146-148 | 2.70-2.80 | 5.98-6.00 | 5.45-5.55 | | |
| | OBC | pulverized pellet | Dow Chemical Company | infuse ™ OBC 9107 | 50 | 0.75-1.25 (190° C.) | 120-122 | | | (“PR023”) | | |
| | CEBC | pellet | JSR Corporation | Dynamic 6200P | 10 | 1.0-5.0 (230° C.) | 94-96 | | | | | |
| example D2 | PP RCP | pulverized pellet | Total Petrochemicals, USA | 6232 | 40 | 1.8-2.4 (230° C.) | 146-148 | 2.70-2.80 | 4.70-4.80 | 5.45-5.55 | | |
| | OBC | pulverized pellet | Dow Chemical Company | infuse ™ OBC 9107 | 50 | 0.75-1.25 (230° C.) | 120-122 | | | (“PR023”) | | |
| | CEBC | pellet | JSR Corporation | Dynamic 6200P | 10 | 1.0-5.0 (230° C.) | 94-96 | | | | | |
| example D3 | PP RCP | pulverized pellet | Total Petrochemicals, USA | 6232 | 40 | 1.8-2.4 (230° C.) | 146-148 | 2.70-2.80 | 4.70-4.90 | 5.45-5.55 | | |
| | OBC | pulverized pellet | Dow Chemical Company | infuse ™ OBC 9107 | 50 | 0.75-1.25 (230° C.) | 120-123 | | | (“PR023”) | | |
| | CEBC | pellet | JSR Corporation | Dynamic 6200P | 10 | 1.0-5.0 (230° C.) | 94-96 | | | | | |

| | | Blending Parameters | | | Extrusion Parameters | | | | | Irradiation Parameters | | | | Foaming Parameters | | | |
|---|---|---|---|---|---|---|---|---|---|---|---|---|---|---|---|---|---|
| | | | | maximum | | | | | foaming | | [symbol] | | | foaming | | | |
| | | low speed | high speed | [symbol] | extrusion | adusion | [symbol] | [symbol] / | [symbol] | [symbol] | beam | | [symbol] | sheet | | [symbol] | formed sheet |
| Resins | | blending | blending | temperature | temperature | rate | [symbol] [symbol] | [symbol] | [symbol] | voltage | current | ( [symbol] | width | supply speed | pre- | temperature | [symbol] speed |
| example | resin type | ( [symbol] c) | ( [symbol] c) | (° C.) | (° C.) | ( [symbol] ) | ( [symbol] ) | ( [symbol] ) | [symbol] | ( [symbol] V) | ( [symbol] ) | patient) | (nm) | ( [symbol] ) | heat | (° C.) | ( [symbol] ) |
| example A1 & | PP RCP | 30 | 530 | 68 | 155 | 175 | 1570 | 23.5 | 1.875 | 800 | 30 | 13.1 | 1200 | 5.0 | yes | 229 | 12.3 |
| B1 | PP RCP | | | | | | | | | | | | | | | | |
| | CEBC | | | | | | | | | | | | | | | | |
| example A2 | PP RCP | 30 | 530 | 68 | 157 | 175 | 1940 | 21.7 | 1.875 | 800 | 30 | 13.1 | 1200 | 5.0 | yes | 229 | 12.5 |
| | PP RCP | | | | | | | | | | | | | | | | |
| | CEBC | | | | | | | | | | | | | | | | |
| example A3 & | PP RCP | 30 | 530 | 78 | 156 | 240 | 1450 | 21.5 | 1.875 | 800 | 30 | 11.9 | 1200 | 5.0 | yes | 229 | 12.4 |
| B2 | PP RCP | | | | | | | | | | | | | | | | |
| | LLOPE | | | | | | | | | | | | | | | | |
| | CEBC | | | | | | | | | | | | | | | | |
| example A4 & | PP RCP | 30 | 530 | 75 | 156 | 240 | 1600 | 23.0 | 1.075 | 800 | 65 | 21.9 | 1200 | 5.0 | yes | 229 | 12.4 |
| B3 | PP RCP | | | | | | | | | | | | | | | | |
| | LLOPE | | | | | | | | | | | | | | | | |
| | CEBC | | | | | | | | | | | | | | | | |
| example A3 | PP RCP | 30 | 530 | 71 | 157 | 240 | 1920 | 21.0 | 1.670 | 800 | 30 | 11.4 | 1200 | 5.0 | yes | 229 | 12.5 |
| | PP RCP | | | | | | | | | | | | | | | | |
| | LLOPE | | | | | | | | | | | | | | | | |
| | CEBC | | | | | | | | | | | | | | | | |
| example A4 | PP RCP | 30 | 530 | 70 | 155 | 175 | 1570 | 23.5 | 1.876 | 800 | 65 | 23.7 | 1200 | 5.0 | yes | 229 | 12.6 |
| | VLDPB | | | | | | | | | | | | | | | | |
| example C1 | impact hPP | 30 | 530 | 66 | 157 | 190 | 1610 | 19.5 | 1.075 | 600 | 50 | 21.2 | 1200 | 7.1 | yes | 230 | 18.8 |
| | PP RCP | | | | | | | | | | | | | | | | |
| | VLDPE | | | | | | | | | | | | | | | | |
| example C2 | impact hPP | 30 | 530 | 66 | 160 | 165 | 1550 | 19.1 | 1.075 | 600 | 62.5 | 21.6 | 1200 | 7.1 | yes | 235 | 18.8 |
| | PP RCP | | | | | | | | | | | | | | | | |
| | VLDPE | | | | | | | | | | | | | | | | |
| example C3 | impact hPP | 30 | 530 | 68 | 160 | 165 | 1540 | 19.2 | 1.075 | 600 | 62.5 | 16.8 | 1200 | 7.1 | yes | 235 | 18.8 |
| | PP RCP | | | | | | | | | | | | | | | | |
| | VLDPE | | | | | | | | | | | | | | | | |
| example D1 | PP RCP | 30 | 530 | 60-72 | 154 | 185 | 2050 | 32.9 | 1.975 | 800 | 55 | 18.8 | 1200 | 5.4 | yes | 233 | 14.4 |
| | OBC | | | | | | | | | | | | | | | | |
| | CEBC | | | | | | | | | | | | | | | | |
| example D2 | PP RCP | 30 | 530 | 64-66 | 154 | 185 | 2060 | 32.4 | 2.100 | 800 | 65 | 16.8 | 1200 | 5.2 | yes | 233 | 13.5 |
| | OBC | | | | | | | | | | | | | | | | |
| | CEBC | | | | | | | | | | | | | | | | |
| example D3 | PP RCP | 30 | 530 | 66-68 | 154 | 185 | 2060 | 32.4 | 2.100 | 800 | 65 | 23.4 | 1200 | 5.4 | yes | 233 | 14.4 |
| | OBC | | | | | | | | | | | | | | | | |
| | CEBC | | | | | | | | | | | | | | | | |

| | | | | | | | | | | | Lamination Quality | | | | |
|---|---|---|---|---|---|---|---|---|---|---|---|---|---|---|---|
| | | Foamed Sheet Parameters | | | | | | Lamination Parameters | | | | | | 200 mm/ [symbol] | 200 mm/ [symbol] |
| | | | | | | lamination | | TPO | | | [symbol] | | | [symbol] tese | [symbol] tese |
| | | | | lamination | overall | surface | | ID/ | | | lorrition [symbol] | 200 mm [symbol] | 200 mm [symbol] | [symbol] , aged | [symbol] , aged |
| | | | | surface | crosslinking | crosslinking | [symbol] | lamination | foam | tran [symbol] tion | [symbol] [symbol] , [symbol] | [symbol] | [symbol] | 120 [symbol] | 120 [symbol] |
| Resins | | st [symbol] trese | density | density | degree | degree | length | process | surface | [symbol] | strength | strength | strength | 120 C. | 120 C. |
| example | resin type | ( [symbol] ) | (g/ml) | (kg/m3) | (%) | (%) | ( [symbol] ) | ID/line ID | heating | gap | ( [symbol] ing) | (ND. [symbol] ) | (TD. [symbol] ) | (ND. [symbol] ) | (TD. [symbol] ) |
| example A1 & | PP RCP | 2.82-2.88 | 102.7-103.3 | 117.3-120.7 | 41.6 | 34.4-34.8 | 2.25-2.30 | A | yes | maximum | 1 | 48.8 | 52.0 | 23.3 | 37.2 |
| B1 | | | | | | | | | | tightness | | | | | |
| | PP RCP | | | | | | | A | yes | 0.10* off | 1 | 48.2 | 50.0 | 30.2 | 39.4 |
| | | | | | | | | | | maximum | | | | | |
| | CEBC | | | | | | | B | no | standard | 1 | 35.0 | 46.2 | 29.2 | 29.6 |
| | | | | | | | | | | tightness | | | | | |
| example A2 | PP RCP | 2.78-2.80 | 103.3-106.1 | 120.0-125.1 | 39.4-40.0 | 35.0-35.8 | 2.30-2.03 | A | yes | maximum | 1 | 45.0 | 50.1 | 32.0 | 40.5 |
| | | | | | | | | | | tightness | | | | | |
| | PP RCP | | | | | | | | | 0.10* off | 1 | 45.2 | 50.3 | 31.6 | 30.7 |
| | | | | | | | | | | maximum | | | | | |
| | CEBC | | | | | | | | | | | | | | |
| example A3 & | PP RCP | 2.80-3.03 | 958-97.6 | 111.8-114.9 | 39.9-40.8 | 34.5-31.9 | 1.80-1.87 | A | yes | maximum | 1 | 45.8 | 47.8 | 34.7 | 36.8 |
| B2 | | | | | | | | | | tightness | | | | | |
| | PP RCP | | | | | | | A | yes | 0.010* off | 1 | 46.0 | 47.0 | 37.1 | 36.5 |
| | | | | | | | | | | maximum | | | | | |
| | LLOPE | | | | | | | B | no | standard | 1 | 40.7 | 59.6 | 30.0 | 32.6 |
| | | | | | | | | | | tightness | | | | | |
| | CEBC | | | | | | | | | | | | | | |
| example A4 & | PP RCP | 2.96-2.99 | 100.3-100.4 | 109.8-115.1 | 44.8 | 38.5-39.5 | 2.03-2.09 | A | yes | maximum | 1 | 43.6, 40.5 | 49.0, 43.4 | 32.0, 94.6 | 37.5, 95.5 |
| B3 | | | | | | | | | | tightness | | | | | |
| | PP RCP | | | | | | | A | yes | 0.010* off | 1 | 48.2, 48.3 | 50.0, 52.1 | 34.1, 35.5 | 38.4. 48.4 |
| | | | | | | | | | | maximum | | | | | |
| | LLOPE | | | | | | | B | no | standard | 1 | 39.7 | 43.3 | 26.9 | 32.1 |
| | | | | | | | | | | tightness | | | | | |
| | CEBC | | | | | | | | | | | | | | |
| example A3 | PP RCP | 2.92-2.94 | 98.4-99.6 | 116.8-120.1 | 39.9-40.1 | 26.6-37.2 | 1.86-1.97 | A | yes | maximum | 1 | 47.8 | 49.5 | 94.2 | 41.3 |
| | | | | | | | | | | tightness | | | | | |
| | PP RCP | | | | | | | | | 0.010* off | 1 | 46.6 | 50.1 | 34.6 | 36.5 |
| | | | | | | | | | | maximum | | | | | |
| | LLOPE | | | | | | | | | | | | | | |
| | CEBC | | | | | | | | | | | | | | |
| example A4 | PP RCP | 3.01-3.11 | 65.3-38.9 | 110.1-115.7 | 32.9-31.1 | 32.9-34.1 | 1.53-1.56 | A | yes | maximum | 1 | 46.6 | 47.3 | 29.0 | 34.5 |
| | | | | | | | | | | tightness | | | | | |
| | VLDPE | | | | | | | | | 0.010* off | 1 | 45.7 | 47.2 | 29.5 | 35.3 |
| | | | | | | | | | | maximum | | | | | |
| example C1 | impact hPP | 2.06-2.09 | 71.2-71.9 | n/m | 38.8-39.6 | 34.8 | 1.28-1.32 | C | no | maximum | 1 | 34.5 | 31.2 | 25.5 | 26.7 |
| | | | | | | | | | | tightness | | | | | |
| | PP RCP | | | | | | | | | | | | | | |
| | VLDPE | | | | | | | | | | | | | | |
| example C2 | impact hPP | 2.02-2.06 | 72.6-75.2 | n/m | 44.4 | 40.0 | 1.29-1.34 | C | no | maximum | 1 | 35.2 | 30.0 | 22.7 | 23.7 |
| | | | | | | | | | | tightness | | | | | |
| | PP RCP | | | | | | | | | | | | | | |
| | VLDPE | | | | | | | | | | | | | | |
| example C3 | impact hPP | 2.02-2.15 | 66.0-70.6 | n/m | 32.2-53.2 | 45.3 | 1.15-1.28 | C | no | maximum | 1 | 27.5 | 29.6 | 20.2 | 21.2 |
| | | | | | | | | | | tightness | | | | | |
| | PP RCP | | | | | | | | | | | | | | |
| | VLDPE | | | | | | | | | | | | | | |
| example D1 | PP RCP | 3.64-3.81 | 60.1-68.9 | n/m | 45.9 | n/m | 0.49 | D | no | standard | 1 | 18.6 | 24.7 | 17.6 | 17.5 |
| | | | | | | | | | | tightness | | | | | |
| | OBC | | | | | | | | | | | | | | |
| | CEBC | | | | | | | | | | | | | | |
| example D2 | PP RCP | 3.66-3.67 | 78.2-77.1 | n/m | 45.3-47.3 | n/m | 0.55-0.59 | D | no | standard | 1 | 24.6 | 22.0 | 26.5 | 16.4 |
| | | | | | | | | | | tightness | | | | | |
| | OBC | | | | | | | | | | | | | | |
| | CEBC | | | | | | | | | | | | | | |
| example D3 | PP RCP | 3.34-3.47 | 81.2-84.0 | n/m | 37.1-37.7 | n/m | 0.55-0.56 | D | no | standard | 1 | 22.7 | 23.4 | 18.8 | 25.2 |
| | | | | | | | | | | tightness | | | | | |
| | OBC | | | | | | | | | | | | | | |
| | CEBC | | | | | | | | | | | | | | |

[symbol]

indicates data missing or illegible when filed

TABLE II

| Resins | | | | | | | | | | | | |
|---|---|---|---|---|---|---|---|---|---|---|---|---|
| | | | | | | | DSC methods | Additives | | | | |
| | | | | | | | temperature | DVB | ADCA | u [symbol] | [symbol] | |
| | resin | | | commercial | amount | MF1 | peak | crosslinker | boiling agent | package | package | [symbol] |
| example | type | form | manufacturer | name | (%) | (2.16 [symbol] ) | (° C.) | (PPHR) | [symbol] off (PPHR) | (PPHR) | (PPHR) | (PPHR) |
| comparative | PP RCP | Pulverized Pellet | Braskem PP Americas | TR3020F | 40 | 1.7-2.5 (230° C.) | 146-148 | 2.70-2.75 | 2.95-3.05 | 4.95-5.05 | 0.87-0.97 | |
| example A1 | PP RCP | flake | Total Petrochemical, USA | T250FL | 40 | 1.3-1.6 (230° C.) | 137-139 | | | (“PRO23”) | (“PRO15”) | |
| | LLDPE | pulverized pellet | Exxonmobil Chemical Co. | LLP8501.67 | 20 | 5.9-7.5 (190° C.) | 125-127 | | | | | |
| comparative | PP RCP | Pulverized Pellet | Braskem PP Americas | TR3020F | 40 | 1.7-2.5 (230° C.) | 146-148 | 3.45-3.55 | 3.70-3.00 | 7.70-7.80 | | |
| example A2 | PP RCP | flake | Total Petrochemical, USA | T250FL | 40 | 1.3-1.6 (230° C.) | 137-139 | | | (“PRO23”) | | |
| | LLDPE | pulverized pellet | Exxonmobil Chemical Co. | LLP8501.67 | 20 | 5.9-7.5 (190° C.) | 125-127 | | | | | |
| comparative | PP RCP | Pulverized Pellet | Braskem PP Americas | TR3020F | 40 | 1.7-2.5 (230° C.) | 146-148 | 3.45-3.55 | 3.96-4.05 | 7.70-7.80 | | |
| example A3 | PP RCP | flake | Total Petrochemical, USA | T250FL | 40 | 1.3-1.6 (230° C.) | 137-139 | | | (“PRO23”) | | |
| | LLDPE | pulverized pellet | Exxonmobil Chemical Co. | LLP8501.67 | 20 | 5.9-7.5 (193° C.) | 125-127 | | | | | |
| comparative | PP RCP | Pulverized Pellet | Braskem PP Americas | TR3020F | 40 | 1.7-2.5 (230° C.) | 146-148 | 3.45-3.55 | 3.70-3.80 | 7.70-7.80 | 0.87-0.97 | |
| example A4 | PP RCP | flake | Total Petrochemical, USA | T250FL | 40 | 1.3-1.6 (230° C.) | 137-139 | | | (“PRO23”) | (“PRO15”) | |
| | LLDPE | pulverized pellet | Exxonmobil Chemical Co. | LLP8501.67 | 20 | 5.9-7.5 (190° C.) | 125-127 | | | | | |
| comparative | PP RCP | Pulverized Pellet | Braskem PP Americas | TR3020F | 40 | 1.7-2.5 (230° C.) | 146-148 | 3.45-3.55 | 3.70-3.00 | 7.70-7.80 | 0.87-0.97 | |
| example A5 | PP RCP | flake | Total Petrochemical, USA | T250FL | 40 | 1.3-1.6 (230° C.) | 137-139 | | | (“PRO23”) | (“PRO15”) | |
| & B1 | LLDPE | pulverized pellet | Exxonmobil Chemical Co. | LLP8501.67 | 20 | 5.9-7.5 (190° C.) | 125-127 | | | | | |
| comparative | PP RCP | Pulverized Pellet | Braskem PP Americas | TR3020F | 40 | 1.7-2.5 (230° C.) | 146-148 | 3.45-3.55 | 3.70-3.00 | 7.70-7.80 | 0.87-0.97 | |
| example B2 | PP RCP | flake | Total Petrochemical, USA | T250FL | 40 | 1.3-1.6 (230° C.) | 137-139 | | | (“PRO23”) | (“PRO15”) | |
| | LLDPE | pulverized pellet | Exxonmobil Chemical Co. | LLP8501.67 | 20 | 5.9-7.5 (190° C.) | 125-127 | | | | | |
| comparative | PP RCP | Pulverized Pellet | Braskem PP Americas | TR3020F | 40 | 1.7-2.5 (230° C.) | 146-148 | 2.76-2.80 | 5.89-6.09 | 4.95-5.05 | | |
| example C1 | PP RCP | flake | Total Petrochemical, USA | T250FL | 40 | 1.3-1.6 (230° C.) | 137-139 | | | (“PRO23”) | | |
| | LLDPE | pulverized pellet | Exxonmobil Chemical Co. | LLP8501.67 | 20 | 5.9-7.5 (190° C.) | 125-127 | | | | | |
| comparative | PP RCP | pulverized pellet | Total Petrochemical, USA | 6232 | 40 | 1.6-2.4 (230° C.) | 146-148 | 2.70-2.83 | 5.99-6.09 | 4.95-5.05 | | |
| example C2 | PP RCP | flake | Total Petrochemical, USA | T250FL | 40 | 1.3-1.6 (230° C.) | 137-139 | | | (“PRO23”) | | |
| | LLDPE | pulverized pellet | Exxonmobil Chemical Co. | LLP8501.67 | 20 | 5.9-7.5 (190° C.) | 125-127 | | | | | |
| comparative | PP RCP | pulverized pellet | Total Petrochemical, USA | 6232 | 40 | 1.6-2.4 (230° C.) | 146-148 | 3.45-3.55 | 5.93-6.09 | 4.90-5.05 | | |
| example C3 | PP RCP | flake | Total Petrochemical, USA | T250FL | 50 | 1.3-1.6 (230° C.) | 137-139 | | | (“PRO23”) | | |
| | LLDPE | pulverized pellet | Exxonmobil Chemical Co. | LLP8501.67 | 20 | 5.9-7.5 (190° C.) | 125-127 | | | | | |
| | CEBC | Pellet | JSR Corporation | Dynamn 6200P | 10 | 1.0-5.0 (230° C.) | 94-96 | | | | | |
| comparative | PP RCP | Pulverized Pellet | Braskem PP Americas | TR3020F | 40 | 1.7-2.5 (230° C.) | 146-148 | 2.70-2.80 | 5.95-6.05 | 5.45-5.55 | | |
| example D1 | OBC | Pulverized Pellet | Dow Chemical Company | Infuse OBC 9107 | 60 | 9.75-1.25 (130° C.) | 120-122 | | | (“PRO23”) | | |

| | | Blending Parameters | | | | | | | | | | | | | | | |
|---|---|---|---|---|---|---|---|---|---|---|---|---|---|---|---|---|---|
| | | | | maximum | Extrusion Parameters | | | | | Irradiation Parameters | | | | Foaming Parameters | | | |
| Resins | | low speed | high speed | [symbol] | extrasion | adusion | [symbol] / | | | irridation | [symbol] beam | [symbol] | [symbol] | foaming sheet | | foaming | foamed sheet |
| | resin | blending | blending | temperature | temperature | rate | [symbol] [symbol] | [symbol] | [symbol] | voltage | current | [symbol] | width | supply speed | pre- | temperature | [symbol] speed |
| example | type | ( [symbol] c) | ( [symbol] c) | (° C.) | (° C.) | ( [symbol] ) | ( [symbol] ) | ( [symbol] ) | [symbol] [symbol] | ( [symbol] V) | ( [symbol] ) | ( [symbol] patient) | (nm) | [symbol] | heat | (° C.) | [symbol] ) |
| comparative | PP RCP | 30 | 530 | 67 | 154 | 240 | 16.30 | 20.2 | 1.875 | 800 | 66 | 17.0 | 1200 | 6.0 | yes | 236 | 15.5 |
| example A1 | PP RCP | | | | | | | | | | | | | | | | |
| | LLDPE | | | | | | | | | | | | | | | | |
| comparative | PP RCP | 30 | 530 | 64-68 | 157 | 240 | 17.30 | 18.5 | 1.875 | 800 | 30 | 11.4 | 1200 | 5.0 | yes | 226-228 | 12.0-13.0 |
| example A2 | PP RCP | | | | | | | | | | | | | | | | |
| | LLDPE | | | | | | | | | | | | | | | | |
| comparative | PP RCP | 30 | 530 | 67 | 157 | 240 | 1740 | 18.7 | 1.875 | 800 | 30 | 11.4 | 1200 | 5.3 | yes | 226 | 13.0 |
| example A3 | PP RCP | | | | | | | | | | | | | | | | |
| | LLDPE | | | | | | | | | | | | | | | | |
| comparative | PP RCP | 30 | 530 | 68 | 155 | 240 | 14.50 | 18.8 | 1.875 | 800 | 30 | 11.9 | 1200 | 5.0 | yes | 237 | 13.0 |
| example A4 | PP RCP | | | | | | | | | | | | | | | | |
| | LLDPE | | | | | | | | | | | | | | | | |
| comparative | PP RCP | 30 | 630 | 74 | 156 | 240 | 15.10 | 21.9 | 1.875 | 800 | 30 | 11.9 | 1200 | 5.0 | yes | 229 | 12.5 |
| example A5 | PP RCP | | | | | | | | | | | | | | | | |
| & B1 | LLDPE | | | | | | | | | | | | | | | | |
| comparative | PP RCP | 30 | 530 | 64 | 157 | 243 | 1570 | 23.0 | 1.875 | 900 | 65 | 20.4 | 1200 | 5.0 | yes | 232 | 13.1 |
| example B2 | PP RCP | | | | | | | | | | | | | | | | |
| | LLDPE | | | | | | | | | | | | | | | | |
| comparative | PP RCP | 30 | 530 | 73 | 160 | 240 | 16.90 | 26.3 | 1.075 | 600 | 65 | 15.8 | 1200 | 7.2 | yes | 237 | 20.2 |
| example C1 | PP RCP | | | | | | | | | | | | | | | | |
| | LLDPE | | | | | | | | | | | | | | | | |
| comparative | PP RCP | 30 | 530 | 63 | 160 | 210 | 16.40 | 26.4 | 1.075 | 600 | 65 | 15.8 | 1200 | 7.2 | yes | 237 | 20.2 |
| example C2 | PP RCP | | | | | | | | | | | | | | | | |
| | LLDPE | | | | | | | | | | | | | | | | |
| comparative | PP RCP | 30 | 530 | 66 | 163 | 210 | 1710 | 27.6 | 1.075 | 600 | 65 | 15.8 | 1200 | 7.2 | yes | 237 | 20.2 |
| example C3 | PP RCP | | | | | | | | | | | | | | | | |
| | LLDPE | | | | | | | | | | | | | | | | |
| | CEBC | | | | | | | | | | | | | | | | |
| comparative | PP RCP | 30 | 530 | 67-68 | 148 | 195 | 23200 | 26.8 | 1.975 | 800 | 65 | 23.4 | 1200 | 5.2 | yes | 232 | 14.3 |
| example D1 | OBC | | | | | | | | | | | | | | | | |

| | | | | | | | | | | | Lamination Quality | | | | |
|---|---|---|---|---|---|---|---|---|---|---|---|---|---|---|---|
| | | Foamed Sheet Parameters | | | | | | Lamination Parameters | | | | | | 200 mm/ [symbol] | 200 mm/ [symbol] |
| | | | | | | lamination | | TPO | | | [symbol] | | | [symbol] tese | [symbol] tese |
| | | | | lamination | overall | surface | | ID/ | | | lorrition [symbol] | 200 mm [symbol] | 200 mm [symbol] | [symbol] , aged | [symbol] , aged |
| Resins | | | | surface | crosslinking | crosslinking | [symbol] | lamination | foam | | [symbol] [symbol] , [symbol] | [symbol] | [symbol] | 120 [symbol] | 120 [symbol] |
| | resin | st [symbol] trese | density | density | degree | degree | length | process ID/ | surface | [symbol] | strength | strength | strength | 120 C. | 120 C. |
| example | type | ( [symbol] ) | (g/ml) | (kg/m3) | (%) | (%) | ( [symbol] ) | line ID | heating | gap | ( [symbol] ing) | (ND. [symbol] ) | (TD. [symbol] ) | (ND. [symbol] ) | (TD. [symbol] ) |
| comparative | PP RCP | 2.75-2.86 | 105.8-109.2 | 108.4-112.3 | 43.6-44.4 | 38.9-40.1 | 2.67-2.90 | A | no | 50% of | 5 | 28.3 | 28.7 | 17.0 | 17.6 |
| example A1 | | | | | | | | | | maximum | | | | | |
| | PP RCP | | | | | | | | | | | | | | |
| | LLDPE | | | | | | | | | | | | | | |
| comparative | PP RCP | 2.95-3.00 | 100.2-103.1 | 117.8-119.2 | 41.6-42.2 | 33.9-34.0 | 2.27-2.87 | A | yes | maximum | 1 | 26.8-40.0 | 44.4-49.5 | 16.5-17.0 | 18.5-18.8 |
| example A2 | | | | | | | | | | tightness | | | | | |
| | PP RCP | | | | | | | | | | | | | | |
| | LLDPE | | | | | | | | | | | | | | |
| comparative | PP RCP | 2.94-2.95 | 102.3-103.8 | 123.9-130.0 | 40.7-41.3 | 33.9-34.0 | 2.57-2.64 | A | yes | maximum | 1 | 34.9-28.9 | 47.8-40.8 | 15.6-18.3 | 19.8-20.6 |
| example A3 | | | | | | | | | | tightness | | | | | |
| | PP RCP | | | | | | | | | | | | | | |
| | LLDPE | | | | | | | | | | | | | | |
| comparative | PP RCP | 2.96-3.11 | 93.2-99.7 | 108.0-112.8 | 40.5-40.6 | 31.8-33.0 | 2.52-2.55 | A | yes | maximum | 1.1 | 37.1-38.2 | 39-2-43.3 | 15.2-15.3 | 22.4-17.8 |
| example A4 | | | | | | | | | | tightness | | | | | |
| | PP RCP | | | | | | | | | | | | | | |
| | LLDPE | | | | | | | | | | | | | | |
| comparative | PP RCP | 2.96 | 98.4-99.2 | 122.3-123.3 | 38.5-38.6 | 31.7-33.0 | 2.37-2.43 | A | yes | maximum | 1 | 42.7 | 42.3 | 31.8 | 25.5 |
| example A5 | | | | | | | | | | tightness | | | | | |
| & B1 | PP RCP | | | | | | | A | yes | 0.10* off | 1 | 41.2 | 40.2 | 22.3 | 25.3 |
| | | | | | | | | | | maximum | | | | | |
| | LLDPE | | | | | | | B | no | standard | 1 | 26.6 | 25.7 | 15.8 | 17.5 |
| | | | | | | | | | | tightness | | | | | |
| comparative | PP RCP | 2.89-2.92 | 97.1-99.0 | n/m | 41.8-42.7 | n/m | 2.35-2.42 | B | no | standard | 1 | 24.8 | 25.0 | 17.1 | 19.0 |
| example B2 | | | | | | | | | | tightness | | | | | |
| | PP RCP | | | | | | | | | | | | | | |
| | LLDPE | | | | | | | | | | | | | | |
| comparative | PP RCP | 2.01-2.05 | 63.4-66.9 | n/m | 42.9 | 37.9 | n/m | C | no | maximum | 4 | 28.7 | 27.2 | 24.7 | 21.2 |
| example C1 | | | | | | | | | | tightness | | | | | |
| | PP RCP | | | | | | | | | | | | | | |
| | LLDPE | | | | | | | | | | | | | | |
| comparative | PP RCP | 20.1 | 68.1 | 75.0 | 43.9-44.1 | 36.9-37.9 | 1.39 | C | no | maximum | 5 | 22.7 | 20.7 | 21.8 | 21.5 |
| example C2 | | | | | | | | | | tightness | | | | | |
| | PP RCP | | | | | | | | | | | | | | |
| | LLDPE | | | | | | | | | | | | | | |
| comparative | PP RCP | 1.92-1.94 | 70.8-72.5 | 78.0 | 46.8 | 40.3-43.8 | 1.14-1.25 | C | no | maximum | 5 | 27.2 | 25.9 | 22.6 | 23.5 |
| example C3 | | | | | | | | | | tightness | | | | | |
| | PP RCP | | | | | | | | | | | | | | |
| | LLDPE | | | | | | | | | | | | | | |
| | CEBC | | | | | | | | | | | | | | |
| comparative | PP RCP | 3.31-3.75 | 65.8-77.5 | n/m | 33.8-35.7 | n/m | 0.48 | D | no | standard | 1 | 12.0 | 16.8 | 12.6 | 22.0 |
| example D1 | | | | | | | (66.5 | | | tightness | | | | | |
| | | | | | | | kg/m²) | | | | | | | | |
| | OBC | | | | | | | | | | | | | | |

[symbol]

indicates data missing or illegible when filed

1. A foam composition comprising about 50 to about 95 parts by weight of at least one polypropylene polymer having a density of about 85 to about 125 kg/m³, wherein the composition has blister rating of 1-2, an unaged peel tear strength of at least about 34 N and a heat aged peel tear strength of at least about 28 N when laminated to a support layer.

2. The foam composition according to claim 1, wherein the support layer is TPO.

3. The foam composition according to claim 1, wherein the polypropylene has a meth flow index of about 0.1 to about 25 g/10 min at 230° C.

4. The foam composition according to claim 1, further comprising an elastic component.

5. The foam composition according to claim 4, wherein the elastic component contains an ethylene component.

6. The foam composition according to claim 4, wherein the elastic component is blended with the polypropylene polymer.

7. The foam composition according to claim 4, wherein the elastic component is polymerized with the polypropylene polymer.

8. The foam composition according to claim 5, wherein the ethylene component is at least one selected from the group consisting of LLDPE, CEBC, OBC, EPR, mPP, MPE, EPDM, SEBS, SEPS, SEEPS, SEP, SEBC, HSB and VLDPE.

9. The foam composition according to claim 1, formed from at least one additive selected from the group consisting of a crosslinking agent, a blowing agent, an antioxidant and an anti-fogging agent.

10. A laminate comprising the foam composition of claim 1 laminated to the support layer.

11. The laminate according to claim 10, wherein the support layer is TPO.

12. The laminate according to claim 10, wherein the foam composition has a thickness of about 0.2 to about 50 mm and the support layer has a thickness of about 0.2 to about 1.2 mm.

13. A foam composition comprising about 50 to about 95 parts by weight of at least one polypropylene polymer having a density of about 50 to about 85 kg/m³, wherein the composition has blister rating of 1-2, an unaged peel tear strength of at least about 26 N and a heat aged peel tear strength of at least about 19 N when laminated to a support layer.

14. The foam composition according to claim 13, wherein the support layer is TPO.

15. The foam composition according to claim 13, wherein the polypropylene has a meth flow index of about 0.1 to about 25 g/10 min at 230° C.

16. The foam composition according to claim 13, further comprising an elastic component.

17. The foam composition according to claim 16, wherein the elastic component contains an ethylene component.

18. The foam composition according, to claim 16, wherein the elastic component is blended with the polypropylene polymer.

19. The foam composition according to claim 16, wherein the elastic component is polymerized with the polypropylene polymer.

20. The foam composition according to claim 17, wherein the ethylene component is at least one selected from the group consisting of LLDPE, CEBC, OBC, EPR, mPP, mPE, EPDM, SEBS, SEPS, SEEPS, SEP, SEBC, HSB and VLDPE.

21. The foam composition according to claim 13, formed from at least one additive selected from the group consisting of a crosslinking agent, a blowing agent, an antioxidant and an anti-fogging agent.

22. A laminate comprising the foam composition of claim 13 laminated to the support layer.

23. The laminate according to claim 22, wherein the support layer is TPO.

24. The laminate according to claim 22, wherein the foam composition has a thickness of about 0.2 to about 50 mm and the support layer has a thickness of about 0.2 to about 1.2 mm.

25. A foam composition comprising about 30 to about 50 parts by weight of at least one polypropylene polymer having a density of about 50 to about 85 kg/m³, wherein the composition has blister rating of 1-2, an unaged peel tear strength of at least about 17 N and a heat aged peel tear strength of at least about 15 N when laminated to a support layer.

26. The foam composition according to claim 25, wherein the support layer is TPO.

27. The foam composition according to claim 25, wherein the polypropylene has a meth flow index of about 0.1 to about 25 g/10 min at 230° C.

28. The foam composition according to claim 25, further comprising an elastic component.

29. The foam composition according to claim 28, wherein the elastic component contains an ethylene component.

30. The foam composition according to claim 28, wherein the elastic component is blended with the polypropylene polymer.

31. The foam composition according to claim 28, wherein the elastic component is polymerized with the polypropylene polymer.

32. The foam composition according to claim 29, wherein the ethylene component is at least one selected from the group consisting of LLDPE, CEBC, OBC, EPR, mPP, mPE, EPDM, SEBS, SEPS, SEEPS, SEP, SEBC, HSB and VLDPE.

33. The foam composition according to claim 25, formed from at least one additive selected from the group consisting of a crosslinking agent, a blowing agent, an antioxidant and an anti-fogging agent.

34. A laminate comprising the foam composition of claim 25 laminated to the support layer.

35. The laminate according to claim 34, wherein the support layer is TPO.

36. The laminate according to claim 34, wherein the foam composition has a thickness of about 0.2 to about 50 mm and the support layer has a thickness of about 0.2 to about 1.2 mm.
